(19) United States
(12) Patent Application Publication
(10) Pub. No.: US 2026/0284472 A1
(43) Pub. Date: Sep. 24, 2026

(54) PORTABLE ARM REHABILITATION TRAINING DEVICE

(71) Applicant: The Hong Kong Polytechnic University, Hong Kong (CN)

(72) Inventor: Nai Kuen FONG, Hong Kong (CN)

(21) Appl. No.: 19/531,831

(22) Filed: Feb. 6, 2026

Related U.S. Application Data
(60) Provisional application No. 63/776,350, filed on Mar. 24, 2025.

(30) Foreign Application Priority Data
Jun. 10, 2025 (CN) 202510769210.5

(51) Int. Cl. A63B 23/12; A61H 1/02; A63B 21/00

(52) U.S. Cl. CPC A63B 23/1281; A61H 1/0285; A63B 21/00178; A63B 21/00181; A63B 2220/51; A63B 2220/54

(57) ABSTRACT

A portable arm rehabilitation training device comprises: a housing having a first surface and a second surface opposite to the first surface; a handle extending from the first surface in a direction away from the first surface and configured for being engageable with a user's hand; a plurality of castors disposed on the second surface of the housing; and a motor assembly disposed within the housing and configured to drive the plurality of castors such that the training device is moveable to facilitate arm rehabilitation. The handle is coupled to the motor assembly such that a forced applied to the handle causes a change in motor current. The training device is configured to be operable in a selected mode in response to a force detection.

### CROSS-REFERENCE TO RELATED APPLICATIONS

This application claims priorities to both the U.S. provisional patent application Ser. No. 63/776,350, filed Mar. 24, 2025, and the Chinese patent application Ser. No. 202510769210.5, filed Jun. 10, 2025, hereby incorporated herein by reference as to their entireties.

### FIELD OF THE DISCLOSURE

The present disclosure relates to rehabilitation training, and in particular to a portable arm rehabilitation training device.

### BACKGROUND

Cerebrovascular accident, commonly known as “stroke”, is an acute disease caused by the sudden rupture of blood vessels in the brain or the inability of blood supply to the brain due to vascular obstruction. The stroke survivors occupy a longer length of hospital stay and higher disability rate, and among them, about 70% may experience permanent hemiparetic upper extremity, while about 33-60% of patients will continue to have no function at six months post-stroke. Upper extremity hemiparesis after stroke is a major problem following hospital discharge; if the patients leave their affected arm unused in daily life, the paralysis can further hinder the further recovery of the upper extremity. Therefore, promoting the recovery of hemiparetic upper extremity is an important area of stroke rehabilitation. One of the purposes of using home-based remote technology was to reduce the need for travelling to the hospitals or healthcare facilities as well as having more intensive therapy at home, thereby reducing the cost for healthcare.

Rehabilitation training devices, such as training robots, have been one of the major technological evolutions in rehabilitation approach of the last decade, because they allow patients to be trained with high dose/intensity, and guide motion and standardized behavior protocols. However, many rehabilitation robots are bulky and mainly used in hospitals/clinics, lacking the flexibility required by home environment or community environment. Additionally, they are so expensive that patients cannot afford to use them at home.

The training robots are commonly classified as wheel-driven end-effector based, arm-driven end-effectors based, and exoskeleton-based. For the exoskeleton-based training robots, they can be connected to human upper limbs as wearable forms, their design is very complicated, and their joints do not match the positions of human joints. Therefore, each joint movement of the above robot requires perfect measurement in terms of angle and torque to the user's upper or lower limbs, in order to achieve normal movement for rehabilitation training. As for the wheel-driven end-effector based and arm-driven end-effector based training robots, they are generally connected to patients through one distal point, although the kinematic model will be simpler, they are bulky and lack the flexibility required by home environment or community environment.

### SUMMARY

One or more embodiments of the present disclosure provide a portable arm rehabilitation training device. The training device comprises: a housing having a first surface and a second surface opposite to the first surface; a handle extending from the first surface in a direction away from the first surface and configured for being engageable with a user's hand; a plurality of castors disposed on the second surface of the housing; and a motor assembly disposed within the housing and configured to drive the plurality of castors such that the training device is moveable to facilitate arm rehabilitation. The handle is coupled to the motor assembly such that a forced applied to the handle causes a change in motor current. The training device is configured to be operable in a selected mode in response to a force detection.

Other embodiments are described herein.

### BRIEF DESCRIPTION OF THE DRAWINGS

FIG. 1 shows a portable arm rehabilitation training device according to certain embodiments of the present disclosure.

FIG. 2 shows a top view of the upper surface of a portable arm rehabilitation training device of FIG. 1.

FIG. 3A shows a side view of the portable arm rehabilitation training device of FIG. 1.

FIG. 3B shows an example manner of engagement between a first surface of the portable arm rehabilitation training device of FIG. 1 and the armrest according to certain embodiments of the present disclosure.

FIG. 3C shows the armrest is adjustable on the first surface of the portable arm rehabilitation training device of FIG. 1 according to certain embodiments of the present disclosure.

FIG. 4 shows a schematic diagram of a use state of a portable arm rehabilitation training device according to certain embodiments of the present disclosure.

FIG. 5 shows a schematic diagram of the left and right movement state of a portable arm rehabilitation training device according to certain embodiments of the present disclosure.

FIG. 6 shows a schematic diagram of the forward and backward movement state of a portable arm rehabilitation training device according to certain embodiments of the present disclosure.

FIG. 7 shows an example motor assembly of a portable arm rehabilitation training device as well as a state of the portable arm rehabilitation training device at the edge of a platform according to certain embodiments of the present disclosure.

FIG. 8 shows a schematic diagram of a portable arm rehabilitation training device placed on a desk according to certain embodiments of the present disclosure.

FIG. 9 shows a schematic diagram of a processor of a portable arm rehabilitation training device according to certain embodiments of the present disclosure.

FIG. 10 is a flowchart of a method for arm rehabilitation according to certain embodiments of the present disclosure.

### SELECTED REFERENCE NUMERALS

1. Status display screen; 2. Mode adjustment knob; 3. Direction adjustment knob; 4. Emergency stop button; 5. Hand rest; 6. Remaining battery display screen; 7. Power switch; 8. Charging interface; 9. Handle; 10. Speed adjustment knob; 11. Distance adjustment knob; 12. Hand pads; 13. Warning tape.

### DETAILED DESCRIPTION

Embodiments of the present disclosure and their advantages can be best understood by referring to the following detailed description. It should be understood that like reference numerals are used to indicate like elements shown in one or more drawings.

One purpose of one or more embodiments is to provide a portable and economical training device, which can be operated on a platform or support, such as a desk or table, and can be used for home or community rehabilitation of hemiparetic upper extremity for users, for example, post-stroke patients or patients with acquired brain injury. As an example application, the training device facilitates or enhances motion recovery by providing structured guidance training, to adapt to each recovery stage or the degree of arm severity after stroke, thereby improving the independence and quality of life of stroke survivors.

According to one or more embodiments, the arm rehabilitation training device can be an arm rehabilitation training robot with compact design, which is convenient to carry and use on a platform, such as a desk or table.

One or more embodiments provide a portable arm rehabilitation training device that is compact in design, convenient to carry, can be operated on a platform, such as a desk or table, and is suitable for home or community rehabilitation. The portable arm rehabilitation training device improves the cost-effective rehabilitation efficacy and improves the quality of life of stroke survivors through greater accessibility to effective treatment.

A portable arm rehabilitation training device according to one or more embodiments of the present disclosure comprises a main body, and the main body comprises a housing. The main body further comprises at least three rolling mechanisms, an infrared sensor, a detection mechanism, a distance control device, a speed control device and a controller, wherein the controller is configured to cause the portable arm rehabilitation training device to execute at least one of a passive mode, an assistive mode and a resistive mode.

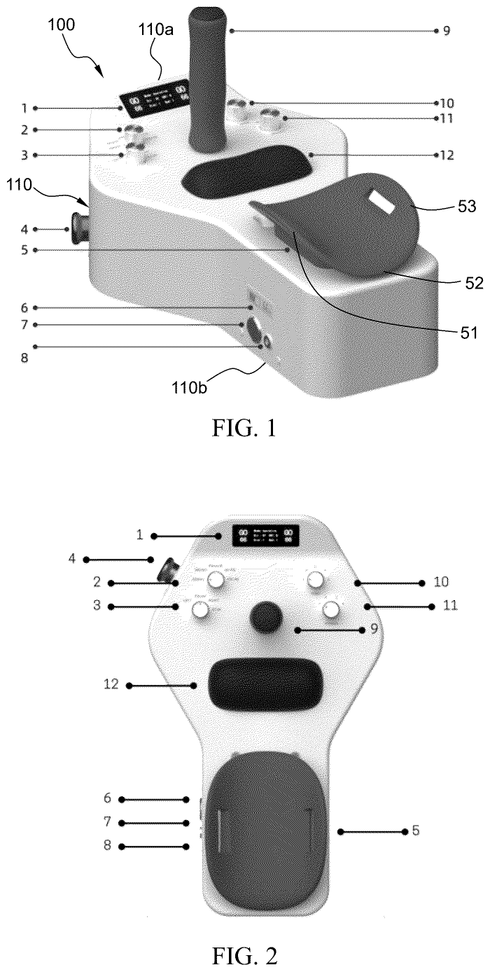

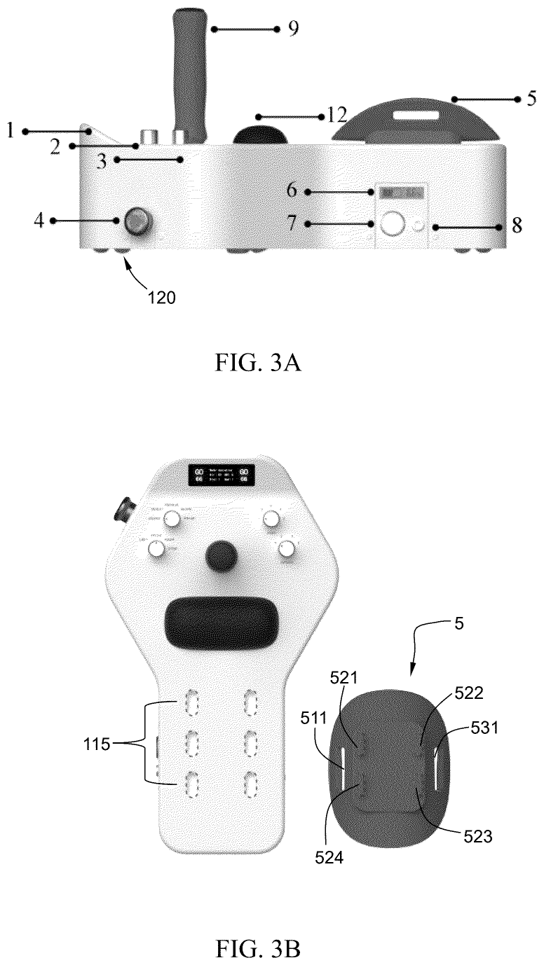

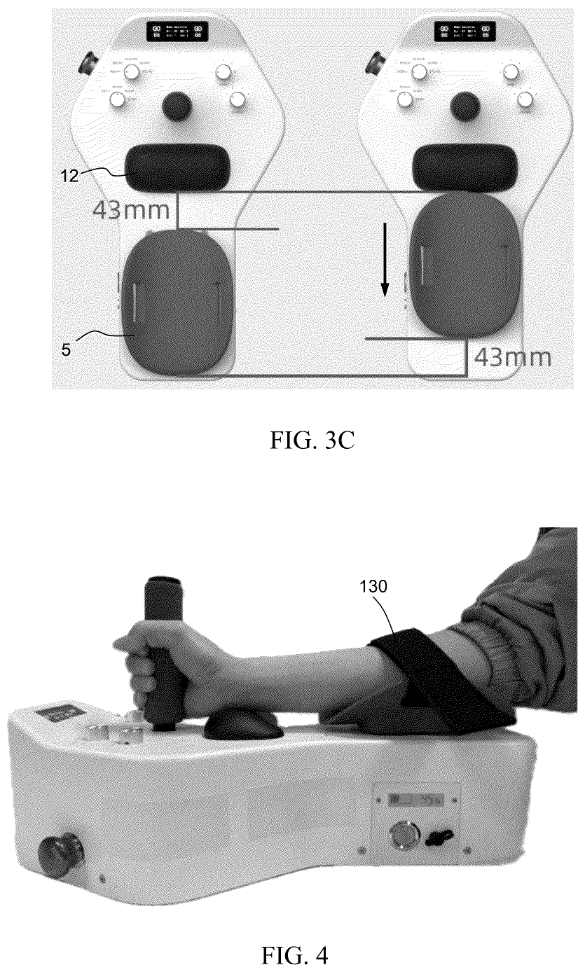

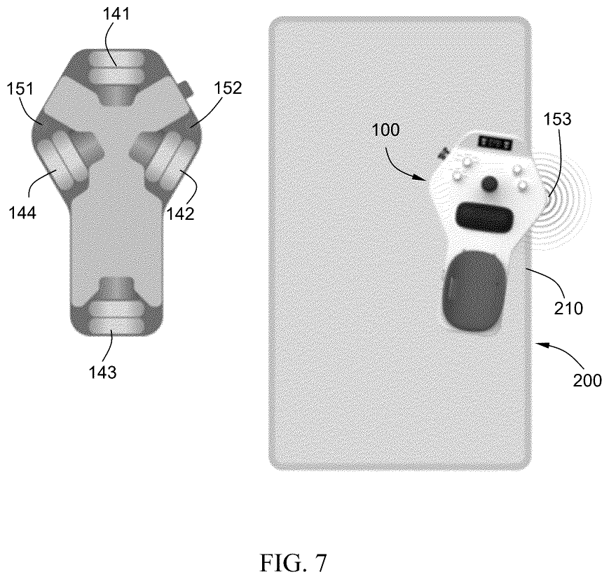

Referring to the drawings, a portable arm rehabilitation training device 100 comprises a housing 110 having a first surface 110a and a second surface 110b opposite to the first surface 110a. A handle 9 extends from the first surface 110a in a direction away from the first surface 110a and configured for being engageable with a user's hand. In certain embodiment as shown in FIG. 1, the handle 9 is substantially perpendicular to the first surface 110a. A plurality of castors 120 (see FIG. 3A) are disposed on the second surface 110b of the housing 110 and facilitates motion of the training device 100 in a desired direction or manner. A motor assembly are disposed within the housing 110 and configured to drive the plurality of castors 120 such that the training device 100 is moveable to facilitate arm rehabilitation. The motor assembly, for example, can comprises four motors 141, 142, 143, 144 as shown in FIG. 7. In certain embodiments, the motor assembly can comprise less than four motors, or five or more motors according to practice needs.

The handle 9 is coupled to the motor assembly such that a forced applied to the handle 9 causes a change in motor current. By way of example, the handle 9 is coupled to one or more motor shafts. In operation, a user applies a force to the handle. This applied force is transmitted to the motor shaft, resulting in a torque or load on the motor. The load causes a corresponding change in the motor current. The change in motor current is detected by one or more current sensing elements, such as Hall effect sensors positioned to measure the magnetic field generated by the current flow, or shunt resistors connected in series with the motor windings to produce a proportional voltage drop across the resistor. The detected current signal (or its derivative, such as magnitude, rate of change, or polarity) provides information indicative of both the magnitude and direction of the force applied by the user to the handle. A controller processes this current information to determine the applied force characteristics and, based thereon, controls operation of the training device accordingly, such as by adjusting motor drive signals, enabling assisted movement, or implementing responsive control functions.

In response to the force detection, the training device 100 can be operable in a selected mode. The selected mode can be selected from a group comprising a passive mode, an assistance mode, resistive mode, and a dual mode. In the passive mode, the training device is configured to move along a predetermined trajectory without requiring active force input from the user. By way of example, the passive mode constitutes a particular rehabilitation training protocol targeted at users (such as patients) exhibiting reduced or absent arm motor function during the initial stages of rehabilitation. In this mode, the training device assumes full control of the movement, supplementing the user's active muscular effort. The training device applies controlled external forces to the user's arm to passively guide it through a range of motions, thereby facilitating joint mobilization, muscle stretching, and circulation improvement without requiring voluntary effort from the user.

In the assistive mode, the training device is configured to provide torque assistance in a direction consistent with the user's motion. By way of example, the assistive mode constitutes a specific rehabilitation training method primarily intended for users (such as patients) whose arm strength is insufficient to actively perform arm movements, wherein the training device provides appropriate assistive force to drive the arm motion, supplementing the user's residual voluntary effort so as to enable completion of intended arm exercises with reduced physical burden, and by delivering controlled external support—typically through actuators, motors, or other proper mechanisms—the device helps guide the arm through flexion, extension, reaching, or other functional movements while the user actively attempts to contribute to the motion to the extent possible, thereby promoting neuroplasticity, encouraging active participation from the user, strengthening remaining muscle function, improving coordination, and accelerating the recovery and enhancement of overall arm functioning during the intermediate stages of rehabilitation where full independent movement is not yet achievable but complete assistance is no longer necessary.

In the resistive mode, the training device is configured to apply resistance opposite to a direction of the user's motion. By way of example, the resistive mode constitutes a specific rehabilitation training method in which the users (such as patients) must overcome resistance generated by the training device to perform arm movements. This resistance-based training effectively strengthens arm muscle power and endurance by requiring the user to exert active force against the device's controlled opposition during flexion, extension, reaching, or other functional movements. As the rehabilitation progresses and the user's capabilities improve, the resistance level can be gradually increased-either manually by a therapist or automatically by the device based on predefined protocols or real-time performance feedback-thereby presenting progressively greater challenges, further enhancing muscle strength, improving endurance, promoting muscular adaptation, and supporting long-term gains in hand functioning during the later stages of recovery where active strengthening becomes a primary goal.

In some embodiments, the dual mode is a combination of the passive mode and the assistive mode. By way of example, the training device first uses the passive mode to completely substitute for the user's effort in performing the extension movement, and then employs the device's assistive drive to help the user complete the arm flexion (or contraction) movement.

In some other embodiments, the dule mode is a combination of the passive mode and the resistive mode. By way of example, the training device not only assists the user in completing arm extension movements through resistive drive, but also fully substitutes for the user's active motor capability in passive mode to retract the hand back, thereby repeatedly performing a cycle of “resistance+passive” rehabilitation training.

In one or more embodiments, the portable arm rehabilitation training device is implemented as or termed as a powered arm skateboard.

According to certain embodiments of the present disclosure, regarding the dimension of the housing 110, without considering the handle 9, the length can be about 350-450 mm, the width is about 200-270 mm, and the height is about 100-180 mm, thereby being suitable for placing the arm. For example, the dimensions of the housing 110 can be 420 mm (length)×245 mm (width)×150 mm (height). The weight of the portable arm rehabilitation training device can be less than 7 kg for convenient carrying, for example, about 3 kg, 4 kg, 5 kg, 6 kg, depending on the used materials. In certain embodiments, the portable arm rehabilitation training device can be made of materials which meet the requirements of low weight and low cost and are suitable for home use. For example, the frame structure of the portable arm rehabilitation training device is composed of carbon fiber plates with high-strength, light-weight and corrosion-resistance, which comprise copper columns for strengthening structural support and electrical connection to cause the structure stable. The armrest 5 is made of ABS plastic, the fixing strap can be a braided belt made of elastic fabric and velcro, and the handle/grip is made of ABS plastic covered with anti-slip rubber.

In certain embodiments, the portable arm rehabilitation training device can operate in various control modes. The selection of the control mode and the related parameters can be seen through the status display screen 1 located on the housing 110, which can be an LED panel, for example, the LED panel with a dimension of 3.12 inches. In certain embodiments, the training device is rechargeable, and a rechargeable battery, for example, a lithium battery pack, is built in. The battery capacity is 2000-4000 mAh, for example, 6000 mAh, and the charging time can be several hours, for example, 1 hour, 2 hours, 3 hours, etc. The rechargeable battery can run continuously for at least 2 hours after being fully charged. Rechargeable battery can provide stable and continuous power supply with a high energy density, and has power display and safety protection mechanism. In certain embodiments, the remaining battery status can be seen through the remaining battery display screen 6 on the side of the main body. The housing is further disposed with a power switch 7 and a charging interface 8 for connecting to an external power supply by a charging cable for charging.

In the certain embodiments, the plurality of castors 120 comprises at least four castors mounted on the second surface of the housing and configured to be driven by the motor assembly to bring the movement of the portable arm rehabilitation training device. In some embodiments, the motor assembly, which act as an actuator, comprises, for example, four brushless DC motors and a core control board. In this embodiment, the plurality of castors can achieve the omni-directional motion and cooperate with the control system to complete the complex path motion. According to certain embodiments of the present disclosure, the actuator has the characteristics of high efficiency, low noise, precise control and the like, and torque control can be achieved by combining current feedback. Therefore, the plurality of castors can drive the portable arm rehabilitation training device to move on a platform, such as a desk or table, and it can move in two different motion modes with opposite directions: 1) the left and right semicircles motion, and 2) the left and right arms forward/backward extension movement, thereby bringing the user to move actively or passively.

As illustrated, an armrest 5 is disposed on the first surface 110a for supporting the user's arm (see FIG. 1, FIG. 4). In some embodiments, the armrest 5 is removably mountable onto the first surface 110a in a pluggable manner. For example, the first surface 110a is provided with a plurality of recesses 115, and the armrest 5 has one side provided with a plurality of protrusions 521, 522, 523, 524. The protrusions and their corresponding recesses can be engaged in a pluggable manner. In some embodiments, the armrest 5 is adjustable in its position on the first surface 110a (see FIG. 3C). For example, the number of recesses (such as six recesses) is greater than the number of protrusions (such as four protrusions). As such, the protrusions can selectively engage with a selected subset of the recesses, thereby adjusting position of the armrest 5 on the first surface 110a of the housing 110, as illustrated in FIG. 3C.

As illustrated in FIG. 1 and FIG. 4, the armrest 5 comprises a lower central portion 52 configured to engage (such as mounted onto) the first surface 110a of the housing 110 and two edge portions 51, 53 extending upwardly and outwardly away from the first surface 110a, thereby defining an ergonomic contour shaped to conform to the user's arm. In some embodiments, the edge portion 52 is provided with a receiving portion in the form of an elongated slit 511, and the edge portion 53 is provided with a receiving portion in the form of an elongated slit 531. In operation, a belt or strap 130 can pass through the two elongated slits and wrap the user's arm for positioning the arm in place. In some embodiments, the armrest 5 can be an inflatable brace to provide customized comfort, or designed universally with elastic materials to adapt to various arm dimensions. Optionally, it can be replaced with a foot brace for lower limb training.

In some embodiments, a hand pad 12 is disposed between the handle 9 and the armrest 5 and configured to support the user's hand. Therefore, the portable arm rehabilitation training device is suitable for arm motion and ergonomics, particularly it can support the forearm, and is smooth enough to slide on the surface of the table or desk through the rolling mechanism.

In certain embodiments, the portable arm rehabilitation training device comprises an edge detector configured to an edge position of the training device. By way of example, the edge detector comprises one or more infrared sensors disposed on the housing and configured to detect a distance of an edge of the training device from an edge of a platform that supports the training device. Referring to FIG. 7, two infrared sensors 151 and 152 are located at the edges of the housing, each arranged to sense the corresponding edge of the housing.

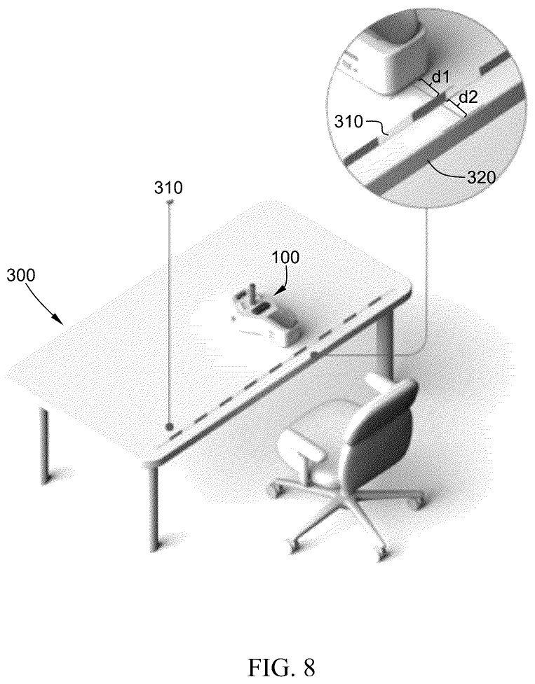

In certain embodiments and as illustrated in FIG. 8, warning tapes 310 in contrasting colors are affixed along the four edges of a platform in the form of table 300 on which the training device 100 is placed. The warning tapes 310 are positioned at a distance (d2) from the table edge 320 that is equal to or greater than a first threshold distance, such as 5 cm, for example, approximately 5 cm or 7 cm. The training device is configured such that its normal operating position maintains at least a second threshold distance, such as a minimum clearance of 5 cm from the warning tapes 310. When the training device approaches within less than this minimum distance from the warning tapes—for instance, when the distance (d1) is less than 5 cm—the infrared sensor on the training device detects the presence of the contrasting warning tape and transmits a signal to a controller. In response, the controller activates a buzzer alarm to alert the user or operator that the training device has reached or is approaching the defined edge safety boundary.

By way of example, the edge detector comprises one or more optical sensors disposed on the housing and configured to detect whether the training device falls off a platform that supports the training device. As further shown in FIG. 7, an optical sensor 153 is provided at an edge of the training device 100 to sense when the training device 100 moves beyond or falls off an edge 210 of the platform 200. For example, the optical sensor 153 detects a change in distance indicative of the training device 100 having slid off the platform 200, and in response thereto, transmits a signal to a controller. In response, the controller activates an audible buzzer alarm and/or trigger an emergency stop of the training device's operation.

In some embodiments, the left side of the portable arm rehabilitation training device is further disposed with another large red emergency stop button 4, which can be pressed for immediate halting use of the training device.

In certain embodiments, the portable arm rehabilitation training device is configured to indirectly achieve the torque detection function through the current feedback values of motors, for example, the current feedback values of four brushless DC motors. In certain embodiments, according to the moment constant of the motor, the controller is configured to convert the detected current feedback value into the corresponding torque value in real time, and then determined the force applied by the user. This detection allows the training device to provide the necessary support when the patient regains part of the autonomous motion, thereby promoting the recovery of active control in some challenging motions (for example, elbow extension and shoulder abduction). In certain embodiments, the portable arm rehabilitation training device can be configured to manually control torque, speed and distance. In certain embodiments, the portable arm rehabilitation training device can be configured to manually control the torque, speed and distance according to the user's actions. In certain embodiments, the portable arm rehabilitation training device can be configured to control the torque, speed and distance according to the settings of a user or an operator. In certain embodiments, the portable arm rehabilitation training device is configured to comprise a force sensor and/or a position sensor, which is configured to measure the user's exertion and manually adjust the assistance accordingly.

Optionally, the torque, speed and distance can be manually monitored/controlled or automatically detected/controlled. Optionally, the data obtained by monitoring and detection are stored in the memory of the training device, and can be remotely operated or extracted by the operator through the transceiver via local area network, wide area network, internet, etc., for measurement and comparison before and after training and across time. Optionally, the training device is configured to be integrated with a telemedicine platform, whereby the data obtained from the monitoring and detection are provided to the telemedicine platform, which can remotely monitor the user's rehabilitation progress, enabling medical staff to track rehabilitation results and adjust treatment protocols accordingly. Optionally, the training device is configured to be connected to the panel of the game or virtual reality program for the purpose of gamification virtual task-specific training in daily life activities, thereby improving the enthusiasm of individuals for simulated training and making up the gap with the use of arms in daily life.

In certain embodiments, optionally, the portable arm rehabilitation training device comprises a mode adjustment knob 2 located on the housing, and through the rotation of the mode adjustment knob 2, rapid conversion is achieved between different operation modes to improve usability. In certain embodiments, the adjustment of the portable arm rehabilitation training device can also be realized through the adjustment options on the touch screen of the housing. In certain embodiments, the mode selection of the portable arm rehabilitation training device is achieved from other clients through remote control.

In certain embodiments, the portable arm rehabilitation training device comprises a direction adjustment knob 3 located on the housing, and the motion direction of the training device can be controlled by the rotation of the direction adjustment knob 3. For example, the motion direction can be vertical forward and backward, or semi-circular motion direction, such as the right arm goes from left to right and reverse, and the left arm goes from right to left and reverse.

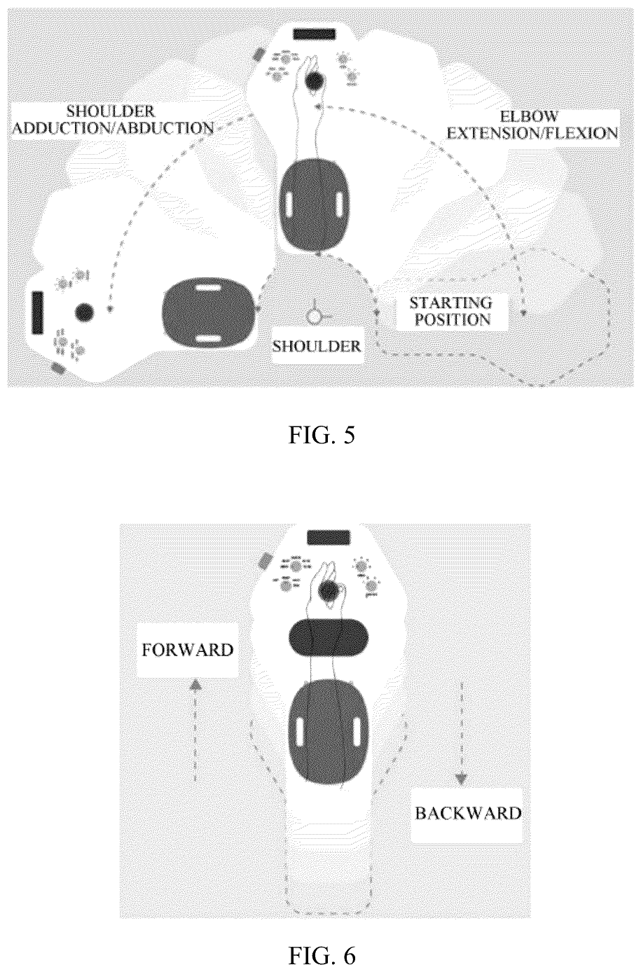

In certain embodiments, as shown in FIG. 5, the training device can be set to conduct a left and right rotation motion along a semicircle. Starting from the starting position on the right side, the training device performs elbow flexion and extension as well as shoulder abduction and adduction actions during the motion. For example, the starting position of the training device is fixed at first, for example, the starting position on the right side, and the direction adjustment knob 3 of the training device is set to the “left side”. Then the controller controls the training device to rotate and extend to the upper left along the motion trajectory, and then rotate and retract along the same trajectory. In one instance, the starting position of the training device is fixed at first, for example, the starting position on the left side, and the direction adjustment knob 3 of the training device is set to the “right side”. Then the controller controls the training device to rotate and extend to the upper right along the motion trajectory, and then rotate and retract along the same trajectory. At the same time, the corresponding angle can be set through the coordination of the distance adjustment knob 11.

In certain embodiments, as shown in FIG. 6, the training device can be set to move forward and backward from the middle starting position. During the movement, the elbow is extended and the shoulder is extended or retracted. In an instance, the starting position of the training device, for example, the middle starting position, is fixed at first, and the direction adjustment knob 3 of the training device is set to the “front side”. Then the training device is controlled by the user to move and extend forward along the motion trajectory, and then to retract backward along the same trajectory. At the same time, the corresponding distance can be set through the coordination of the distance adjustment knob 11.

In certain embodiments, the portable arm rehabilitation training device comprises a distance angle control device for adjusting the relative distance between the arm of the detected user and the use position. For example, as shown in FIG. 1, a distance adjustment knob 11 is disposed on the housing. Through the distance control device, the angle and distance of the motion of the training device can also be controlled. In the certain embodiments, for example, four kinds of distance settings can be provided, and the distance angle control device can make the adjustment according to the following situations: 1) the patient's capability, 2) the length of the individual's arm determined according to their body built, and 3) the size of the tabletop on which the training device runs. Optionally, in certain embodiments, when the direction is in the “left side” or “right side” state, the distance adjustment knob 11 will be automatically switched to the “angle” adjustment state. In an instance, the angle adjustment can be divided into four settings: the first setting is about 80 degrees, the second setting is about 100 degrees, the third setting is about 120 degrees, and the fourth setting is about 140 degrees. Optionally, the angle may also be adjusted by other restriction mechanisms. In certain embodiments, when the direction is in the “front side” state, the distance adjustment knob 11 will automatically switch to the “distance” adjustment state. In one instance, the distance adjustment is divided into four settings: the first setting is 20 cm, the second setting is 30 cm, the third setting is 40 cm, and the fourth setting is 50 cm. Different distances and different angles can be set as needed.

In certain embodiments, the portable arm rehabilitation training device comprises a speed control device for adjusting the speed of motion of the portable arm rehabilitation training device. In an instance, for example, a speed adjustment knob 10 is provided, which offers such as five speed settings, for example, 0.1 m/s, 0.2 m/s, 0.3 m/s, 0.4 m/s and 0.5 m/s, respectively. More or fewer speeds can be set and adjusted according to the user's ability. The speed control is designed with reference to the needs of post-stroke patients. The controller drives the driving device to make the universal wheel move at the selected speed.

Each of the above knobs can be circular and adjustable so as to achieve appropriate adjustment on motion in a vertical or semi-circular direction, motion speed and distance, for adapting the needs of individual users.

In certain embodiments, the portable arm rehabilitation training device comprises a controller, which is coupled with an infrared sensor, a detection mechanism, a distance control device and a speed control device, for controlling the portable arm rehabilitation training device to perform operation in an appropriate mode. For example, the force or torque of the training device is provided by the actuator to allow the switching of training modes, for meeting the needs of patients and achieving the passive, active and assistive modes of rehabilitation training. In certain embodiments, the portable arm rehabilitation training device further comprises a touch screen located on the housing, and the touch screen is configured to provide an interactive interface for the selection of the required operating parameters. In certain embodiments, the controller is configured to receive the operating parameters remotely.

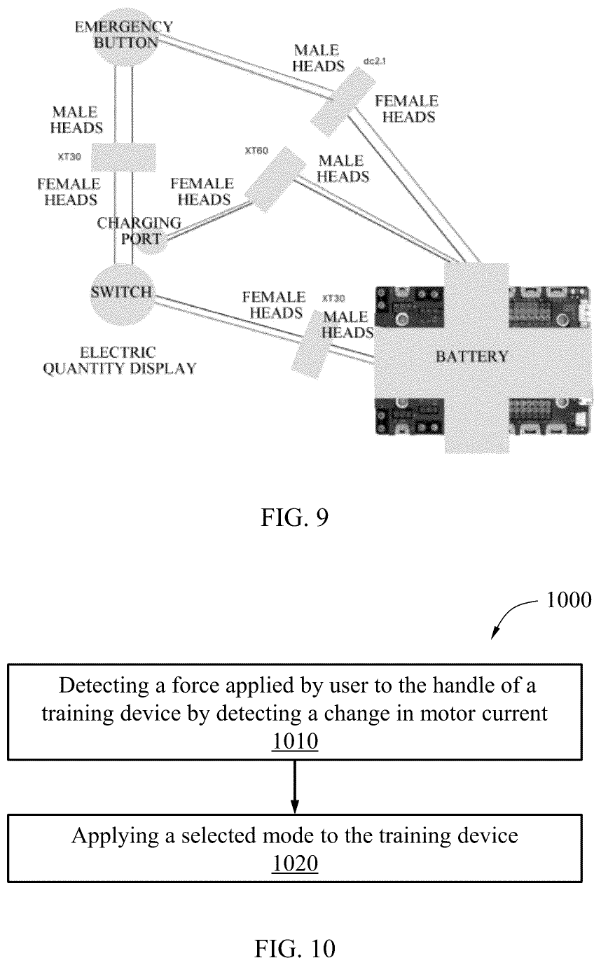

In certain embodiments, the connection mode and communication mode, such as current feedback, distance feedback, etc., between the controller and the sensor of the portable arm rehabilitation training device are shown in FIG. 9. First, the portable arm rehabilitation training device may be configured without an independent torque sensor. In the case that the training device does not have an independent torque sensor, preferably, instead the indirect torque measurement is achieved by a current sensing module built in the motor arranged in the training device. The signal of the indirect torque measurement information is transmitted back to the processor of the controller, for example, the main control board, in real time through the brushless motor driver, for example, the FOC controller, for judging the user's force application situation. The training device is further disposed with an optical sensor, for example, located at the edge of the training device, and the optical sensor can judge whether the training device slides out of the desk or table through the distance change. The controller of the training device is also connected to the switch and the panic button to start and brake urgently, and at the same time. The training device is configured to be charged through the connection with the charging port, and the battery quantity is displayed on the display screen. All the above connections are achieved through the male and female heads. Optionally, the training device can also be configured to comprise a torque sensor.

The transmission path of the signal of the indirect torque measurement information is shown in FIG. 9. First, the user applies a force (by gripping the rod), at which point the motor shaft is subjected to a force. Then, the motor current changes, and the change is sensed by suitable devices, for example, Hall sensing or shunt resistance. The electric adjustment board/driver board collects current information and transmits the current information to processor of the controller through CAN (Controller Area Network) bus communication. The processor calculates the current torque estimate to decide whether to provide assistance or impedance, that is, to output the control signal.

The processor of the controller is connected with the electric adjustment board as the motor controller, and the motor controller comprises a current detection circuit and a CAN communication interface (1 Mbps), and the current detection circuit optionally supports the detection range of 6 A-20 A, and the CAN communication interface is, for example, a 1 Mbps interface. The processor of the controller communicates with the four motor control units of the four rolling mechanisms through the CAN bus to perform reading and writing operations, wherein the real-time current, motor angle and speed are read in the reading operation, and the expected speed/torque instruction is written in the writing operation, which is determined by the training mode.

In certain embodiments, the controller of the portable arm rehabilitation training device converts the current into the corresponding torque value in real time according to the moment constant of the motor (about 0.8-0.9 N·m/A), and then determines the force applied by the user. Optionally, the controller adopts FOC (Field Vector Control) strategy, and under various training modes, the controller achieves the following functions according to the user's action intention and torque feedback.

In certain embodiments, the controller is configured to cause the portable arm rehabilitation training device execute at least one of the following passive mode, assistive mode and active mode, wherein the selected mode can be decided according to the ability condition of the user (patient) or the suggestion of the therapist.
a) Passive mode—In this mode, the portable arm rehabilitation training device is configured to run according to a predetermined trajectory without the user actively exerting force. The portable arm rehabilitation training device is configured to continuously monitor torque (current) and automatically slow down or stop if an abnormal increase is detected so as to ensure safety. In this mode, the training device guides the patient's movement without any active participation, promoting motor learning through individual motions. The passive mode is especially suitable for the user's early recovery stage.
b) Assistive mode—This assistive mode allows the training device to detect active motion through the detection mechanism and provide assistance based on the force applied by the patient. In this mode, the controller is configured to detect the current of the whole system in real time. After the slight active output of the user is detected, the controller immediately increases the motor current to provide moment assistance consistent with the user's action direction to help him complete the target action. The assistive mode encourages active participation, and provides support for individuals who can make some efforts. Particularly this mode is beneficial to promoting elbow extension and shoulder abduction, aligning with Brunnstrom stage of motor recovery. The assistive mode is especially suitable for the stage when the user is advanced enough to provide sufficient applied force.
C) Resistive mode—In this mode, the controller is configured to detect the current of the whole system in real time, and apply a constant or increasing resistance opposite to the user's action direction through the actuator, where the resistance can be adjustable. In this mode, the user needs to actively overcome the resistance to complete the action. The resistive mode allows the user, particularly who is in the final stages of a recovery period, to exert force against the resistance from the training device, for promoting muscle strengthening and endurance. The resistive mode encourages muscle strengthening by requiring individuals to overcome the resistance of robots.

In addition, optionally, a dual-mode form can be set according to requirements, that is, dual-mode (assistive and passive AE+PE; passive and assistive PE+AE)—dual-mode allows the user to customize the training device to combine the assistive mode and the passive mode, in opposite directions of movement, thereby suiting the user's needs according to the user's recovery stage (for example, with reference to Brunnstrom stages of motor recovery), thereby offering a comprehensive rehabilitation experience tailored to the user's current capabilities. For example, dual mode allows combining assistive mode and passive mode in opposite directions, optimizing arm capacity according to individual needs.

Therefore, through this kind of torque estimation and closed-loop control strategy based on current feedback, the portable arm rehabilitation training device according to the present disclosure can achieve precise and reliable motion assistance and training adjustment, and meet the requirements of different rehabilitation stages.

Table 1 below provides common hemiplegic arm movement suggestions and robot-suggested torque control after stroke, and the torque control has been stored in a preset mode and in the memory of the training device, and according to the selected mode, the arm movement and the suggested mode for torque are selected, therefore achieving the control of the training device.

TABLE 1

| | | | suggested |
|---|---|---|---|
| | | | mode for |
| recovery stage | arm site | movement | torque |
| Flaccidity without any active control | elbow | flexion | passive |
| | | extension | passive |
| | shoulder | adduction | passive |
| | | abduction | passive |
| Flexor synergy but no active | elbow | flexion | assistive |
| extension and abduction control | | extension | passive |
| | shoulder | adduction | assistive |
| | | abduction | passive |
| Weak active elbow extension/flexion | elbow | flexion | assistive |
| and shoulder abduction/adduction | | extension | assistive |
| control | shoulder | abduction | assistive |
| | | adduction | assistive |
| full active extension/flexion and | elbow | flexion | resistive |
| abduction/adduction control | | extension | resistive |
| | shoulder | abduction | resistive |
| | | adduction | resistive |

In certain embodiments, the mode selection of the training device is determined in accordance with the capability of the user (patient) or the suggestion of the therapist. The suggested torque mode can be referred to the Table 1 as above. In certain embodiments, the mode of the training device is not changed in accordance with the force of the customer in real time, but the mode, angle, speed and distance settings are changed through an adjusting mechanism, for example, an adjusting knob.

In certain embodiments, in the passive mode, the user is in a relaxed state without any active control, and the training device can guide the patient's motions without any active participation, so as to promote motor learning through personal motions. The controller controls the training device to perform flexion and extension of the elbow and adduction of the shoulder. The controller controls the motor of the universal roller and drives the universal roller to move the training device forward and backward and rotate, so as to achieve the movement of the elbow and shoulder. In certain embodiments, the torque is set according to the user's condition, and the distance, angle and speed of the motion of the training device is controlled through the distance angle control device and the speed control device. In an instance, the user selects the passive mode, adjusts the direction to the “right side”, and both the distance angle control device and the speed control device are arranged at the first setting. The training device brings the user's arm to rotate to the right by an angle of 80 degrees at a speed of 0.1 m/s, and returns, to achieve passive motion. In an instance, the user selects the passive mode, adjusts the direction to the “front side”, and both the distance angle control device and the speed control device are in the second setting. The training device drives the user's arm to move 30 cm to the front side at a speed of 0.2 m/s, and then returns, to achieve passive motion.

In certain embodiments, in the assistive mode, the user is in a state of weak active elbow extension/flexion and shoulder abduction/adduction control, and the training device needs to detect the active motion through the detection mechanism and provide help according to the force applied by the user. The controller controls the distance, angle and speed of the motion of the training device through the distance angle control device and the speed control device, and selects a slightly weaker torque, therefore controlling the training device to perform flexion and extension of the elbow and abduction and adduction motions of the shoulder with the partial participation of the user. In an instance, the user selects the mode as the assistive mode, the direction is adjusted to the “left side”, and both the distance angle control device and the speed control device are in the first setting. The training device drives the user's arm to rotate 80 degrees to the left at a speed of 0.1 m/s with less force, and return.

In certain embodiments, in the resistive mode, the user is in a state of full active extension/flexion and abduction/adduction control, and the training device detects the active motion through the detection mechanism and provides little or no help according to the force applied by the user. The controller provides resistance through the distance angle control device and the speed control device, therefore controlling the training device to perform the flexion and extension of the elbow and the abduction and adduction motions of the shoulder with the full or almost full participation of the user. In an instance, the user selects the mode as resistive mode, adjusts the direction to the “left side”, and both the distance angle control device and the speed control device are in the first setting. The training device provides resistance, prompting the user to exert his own force, so as to drive his arm to rotate to the left by an angle of 80 degrees at a speed of 0.1 m/s, and return.

In certain embodiments, in the passive and assistive/assistive and passive modes, the user is in a state of the flexor synergy without active extension and abduction control, and the training device detects the active motion through the detection mechanism and provides appropriate help according to the user's recovery stage. In the assistive mode the training device provides assistance in elbow flexion and shoulder adduction, and in the passive mode it provides guidance in elbow extension and shoulder abduction of the user. The controller provides assistance through the distance angle control device and the speed control device, therefore controlling the training device to provide different assistance and help when the user performs different actions. In an instance, the user selects the mode as the passive and assistive modes, the direction is adjusted to the “left side”, and both the distance angle control device and the speed control device are in the first setting. The training device drives the user to perform elbow flexion and shoulder adduction with less force, and elbow extension and shoulder abduction with greater force, so as to achieve a rotation by 80-degree to the left side at a speed of 0.1 m/s, and return in the same manner.

A portable arm rehabilitation training device according to another embodiment of the present disclosure comprises a main body comprising a housing.

In certain embodiments, the portable arm rehabilitation training device can run in various control modes. In certain embodiments, the training device is rechargeable, with a built-in rechargeable battery, which is controlled by a power switch disposed on the surface and charged through a charging interface.

In certain embodiments, a handle extending upward is disposed on the housing, which has a suitable form and is disposed at the upper front side of the housing for the user's hand grip. In certain embodiments, four universal casters are disposed below the housing, therefore bringing the motion of the portable arm rehabilitation training device. In an embodiment, the housing is further disposed with an adjustable hand rest at the rear, which has a suitable shape for placing the user's arm.

In certain embodiments, the portable arm rehabilitation training device comprises a detection mechanism located within the housing, which is configured to detect the patient's autonomous motion in the motion process. The detection mechanism transmits the detected signal to the controller, and the controller is configured to lead the portable arm rehabilitation training device to execute at least one of the passive mode, assistive mode and active mode as described above, or a combined mode according to the received operating parameters from the portable arm rehabilitation training device or the operating parameters provided externally. In the certain embodiments, the portable arm rehabilitation training device comprises a mode adjustment knob located on the housing, and the mode adjustment knob can be rotated for achieving rapid conversion between different operation modes. In certain embodiments, by remote control such as through smartphones or tablets, or touch screen selection, etc., the portable arm rehabilitation training device selects and adjusts the portable arm rehabilitation training device by receiving one or more of the operating parameters and the selected mode from the portable arm rehabilitation training device or provided externally, to improve usability.

According to certain embodiments of the present disclosure, a portable arm rehabilitation training device group is also proposed, which comprises two matched portable arm rehabilitation training devices for training the left arm and the right arm together. The two portable arm rehabilitation training devices for the two arms are coordinated in time and space through controllers which communicate with each other, such that the training devices move symmetrically at the same time and bear unpredictable force from the hemiplegic arm.

FIG. 10 is a flowchart of a method 1000 for arm rehabilitation according to certain embodiments of the present disclosure. The method 1000 can be implemented using a portable arm rehabilitation training device in accordance with one or more embodiments as described herein.

Block 1010 states detecting a force applied by user to the handle of a training device by detecting a change in motor current. The motor current's change can be determined by a current sensing module built into the motor. In some embodiments, the force detection is based on estimation of motor's torque. The estimated torque can be obtained indirectly from the motor current's change.

By way of example, in operation, the user actively applies force to move the training device, causing a torque on the motor shaft that results in a corresponding change in motor current. This current variation is detected in real time by current-sensing means such as Hall effect sensors or shunt resistors integrated within the motor drive circuitry, after which the electronic speed controller (ESC) or motor driver board collects the current data and transmits it to the main controller's processor via Controller Area Network (CAN) bus communication. The processor then calculates an estimated motor torque—typically by multiplying the measured current by the motor's torque constant (in one embodiment approximately 0.8 to 0.9 Nm/A)—to indirectly determine both the magnitude and direction of the force applied by the user.

Block 1020 states applying a selected mode to the training device. For example, based on the torque estimation, the controller decides whether to output a control signal that provides assistive torque (to reduce the user's effort) or resistive (impedance) torque (to increase training difficulty). In certain embodiments, the brushless motor is driven by a FOC algorithm implemented on the motor driver board, which enables high-precision current regulation and accurate real-time torque feedback, allowing the system of the portable arm rehabilitation training device to continuously monitor and dynamically adjust the level of assistance or resistance in response to the user's voluntary input for adaptive, intent-based rehabilitation training.

It can be seen that the portable arm rehabilitation training device proposed in the present disclosure is used for home or community rehabilitation, and is intended to promote the recovery of hemiparetic upper extremity in persons with hemiplegia. The training device is light and compact in design, and the battery life is at least two hours after being fully charged, for seamless operation in a home environment or community setting. The training device can run in various modes, comprising passive, assistive, resistive and combined modes, to suit the needs of clients with different levels of arm impairments. The networking version can be set according to the condition, therefore the portable arm rehabilitation training device can be controlled and operated through the controller or the mobile terminal; or a version that does not require an Internet connection can be set up, which can be operated independently without complicated operations. This kind of intervention allows high dosage and intensity of training to the individuals with guided movement and standardized behavior protocols.

The terminology used herein is for the purpose of describing specific exemplary embodiments only and is not intended to be limiting. As used herein, the singular forms “a”, “an” and “the” are also intended to comprise the plural forms unless the context clearly indicates otherwise. The terms “comprising”, “including”, “containing” and “having” are inclusive, thus specifying the presence of said features, integers, steps, operations, elements and/or components, but not excluding the presence or addition of one or more other features, integers, steps, operations, elements, components and/or combinations thereof. Unless the order of execution is explicitly indicated, the method steps, procedures and operations described herein are not to be interpreted as necessarily requiring them to be executed in the specific order discussed or illustrated. It should also be understood that additional or alternative steps may be taken.

When a feature is described as being “on,” “engaged to,” “connected to,” “coupled to,” “associated to,” “included in,” or “in communication with,” it may be directly on, directly engaged to, connected to, coupled to, associated to, included in, or directly in communication with the other feature, or intervening features may be present. As used herein, the term “and/or” comprises any and all combinations of one or more associated listed items.

Again, the foregoing description of the exemplary embodiments has been provided for purposes of illustration and description. Its purpose is not to be exhaustive or to limit this disclosure. Even if not specifically shown or described, individual elements or features of a particular embodiment are generally not limited to this particular embodiment, but are interchangeable and can be used in selected embodiments where applicable. The same situation can be different in many ways. Such variations are not considered a departure from the present disclosure, and all such modifications are intended to be comprised within the scope of the present disclosure.

What is claimed is:

1. A portable arm rehabilitation training device comprising:
a housing having a first surface and a second surface opposite to the first surface;
a handle extending from the first surface in a direction away from the first surface and configured for being engageable with a user's hand;
a plurality of castors disposed on the second surface of the housing; and
a motor assembly disposed within the housing and configured to drive the plurality of castors such that the training device is moveable to facilitate arm rehabilitation;
wherein the handle is coupled to the motor assembly such that a forced applied to the handle causes a change in motor current,
wherein the training device is configured to be operable in a selected mode in response to a force detection.

2. The portable arm rehabilitation training device of claim 1, wherein the selected mode is selected from a group comprising a passive mode, an assistance mode, and resistive mode, wherein:
in the passive mode, the training device is configured to move along a predetermined trajectory without requiring active force input from the user,
in the assistive mode, the training device is configured to provide torque assistance in a direction consistent with the user's motion,
in the resistive mode, the training device is configured to apply resistance opposite to a direction of the user's motion.

3. The portable arm rehabilitation training device of claim 1, wherein the group further comprises a dule mode, and the dule mode is a combination of the passive mode and the assistive mode or a combination of the passive mode and the resistive mode.

4. The portable arm rehabilitation training device of claim 1, wherein the force detection is based on detection of a change in motor current.

5. The portable arm rehabilitation training device of claim 1, wherein the force detection is based on estimation of motor's torque.

6. The portable arm rehabilitation training device of claim 1, further comprising: an edge detector configured to an edge position of the training device.

7. The portable arm rehabilitation training device of claim 6, wherein the edge detector comprises one or more infrared sensors disposed on the housing and configured to detect a distance of an edge of the training device from an edge of a platform that supports the training device.

8. The portable arm rehabilitation training device of claim 6, wherein the one or more infrared sensors are configured to detect a distance of an edge of the training device from a warning tape disposed on a platform that supports the training device.

9. The portable arm rehabilitation training device of claim 6, wherein the edge detector comprises one or more optical sensors disposed on the housing and configured to detect whether the training device falls off a platform that supports the training device.

10. The portable arm rehabilitation training device of claim 1, wherein the motor assembly comprises a plurality of motors coupled to the handle such that the forced applied to the handle passes onto motor shafts for changing motor current or torque.

11. The portable arm rehabilitation training device of claim 1, further comprising an armrest disposed on the first surface for supporting the user's arm, the armrest being adjustable in its position on the first surface.

12. The portable arm rehabilitation training device of claim 11, wherein the armrest is removably mountable onto the first surface in a pluggable manner.

13. The portable arm rehabilitation training device of claim 12, wherein the first surface is provided with a plurality of recesses, and the armrest has one side provided with a plurality of protrusions, wherein the number of recesses is greater than the number of protrusions, the protrusions being configured to selectively engage with a selected subset of the recesses, thereby adjusting position of the armrest on the first surface of the housing.

14. The portable arm rehabilitation training device of claim 11, wherein the armrest comprises a lower central portion configured to engage the first surface of the housing and two edge portions extending upwardly and outwardly away from the first surface, thereby defining an ergonomic contour shaped to conform to the user's arm.

15. The portable arm rehabilitation training device of claim 14, wherein each edge portion of the armrest is provided with a receiving portion for engaging with a strap.

16. The portable arm rehabilitation training device of claim 11, further comprising a hand pad disposed between the handle and the armrest and configured to support the user's hand.

17. A method for arm rehabilitation for a user using a portable arm rehabilitation training device of claim 1, the method comprising:
detecting a force applied by the user to the handle of the training device by detecting a change in motor current; and
applying a selected mode to the training device.

18. The method of claim 17, wherein applying the selected mode comprises:
applying a passive mode such that the training device moves along a predetermined trajectory without requiring active force input from the user.

19. The method of claim 17, wherein applying the selected mode comprises
applying an assistive mode such that the training device provides torque assistance in a direction consistent with the user's motion.

20. The method of claim 17, wherein applying the selected mode comprises:
applying a resistive mode such that the training device applies resistance opposite to a direction of the user's motion.
